(19) United States
(12) Patent Application Publication
(10) Pub. No.: US 2019/0286248 A1
(43) Pub. Date: Sep. 19, 2019

(54) FOLDING KEYBOARD WITH SLIDING KEY ROWS

(71) Applicant: William James McDermid, Niwot, CO (US)

(72) Inventor: William James McDermid, Niwot, CO (US)

(21) Appl. No.: 15/924,274

(22) Filed: Mar. 19, 2018

(51) Int. Cl. G06F 3/02; G06F 1/16

(52) U.S. Cl. CPC G06F 3/0221; G06F 1/1669; G06F 1/1666

(57) ABSTRACT

A method and apparatus for folding a keyboard along one or more vertical axes where the staggered rows on a standard QWERTY keyboard are slid into alignment prior to folding to simplify the folding mechanism and further reduce the footprint of the device when folded.

### CROSS REFERENCE TO RELATED APPLICATIONS

This non-provisional application claims priority to U.S. provisional application 62/447,914 filed on Jan. 19, 2017, which is incorporated herein by reference.

### BACKGROUND OF THE INVENTION

### 1. Field of the Invention

This invention relates to an apparatus and a method for folding a computer keyboard where the staggered rows on a standard QWERTY keyboard are slid into alignment prior to folding to simplify the folding mechanism and to reduce the footprint of the keyboard when folded.

### 2. Statement of the Problem

With the proliferation of mobile computer devices such as smart-phones and tablets, it is convenient to have a keyboard that can fold into a small package suitable for carrying in a pocket or small tote. The staggered rows on a QWERTY keyboard make it difficult to make a keyboard that folds along vertical axes.

### SUMMARY OF THE SOLUTION

The present invention solves the above and other problems with a computer keyboard where the rows of keys can slide relative to one-another. The rows of keys can slide so the keys are in a standard staggered arrangement for use when typing. The rows of keys can also slide so the keys are in vertical alignment to reveal straight vertical axes along which the keyboard can fold.

### ASPECTS

An aspect of the invention is how the rows of keys slide relative to one another to be in the staggered arrangement of a QWERTY keyboard or in an arrangement where the keys are aligned in columns.

Another aspect of the invention is how the keyboard folds along axes between columns of keys.

Preferably, the keyboard folds into thirds along two axes.

Alternatively, the keyboard can fold into fourths along three axes, or into halves along one axis.

Another aspect of the invention is how the rows lock the keyboard in the unfolded open state when slid into the staggered position.

Another aspect of the invention is how mechanical linkages can coordinate all the rows to maintain proportional relative relationships among all the of rows based on the sliding position between two of the rows.

Preferably, the linkages are comprised of fixed-length flexible straps.

Alternatively, the linkages are comprised of mechanical racks and pinions.

Another aspect of the invention is how the row with the spacebar key slides to keep the spacebar key in vertical alignment with the home row keys. This aligned row may also contain a track pad.

Another aspect of the invention is how the keyboard can be incorporated into a case for a smart-phone.

Another aspect of the invention is how the keyboard can fit into a cavity formed from the inside folds of a device with a foldable display.

### DESCRIPTION OF THE DRAWINGS

The above and other advantages and features of the invention may be better understood from a reading of the detailed description taken in conjunction with the drawings. The same reference number represents the same element on all drawings.

FIG. 1A is a top view of a tri-folding keyboard where the key rows are slid to align the keys into columns for folding. FIG. 1B is a top view of a tri-folding keyboard where the key rows are slid to a standard QWERTY staggered arrangement for typing.

FIG. 2A is a side view of the tri-folding keyboard in FIG. 1A.

FIG. 2B is a side view of the tri-folding keyboard where the ends are beginning to fold up.

FIG. 2C is a side view of the tri-folding keyboard in its folded state.

FIG. 2D is a top view of the tri-folding keyboard in its folded state.

FIG. 3A is an isometric view of two banks of 4 keys each showing tabs that connect it to the banks shown in FIG. 3B.

FIG. 3B is an isometric view of two banks of 4 keys each showing slots that receive the tabs shown in FIG. 3A.

FIG. 4 is a top view of a cross section of the keyboard showing straps that maintain the relative position of rows during a sliding event.

### DETAILED DESCRIPTION OF THE INVENTION

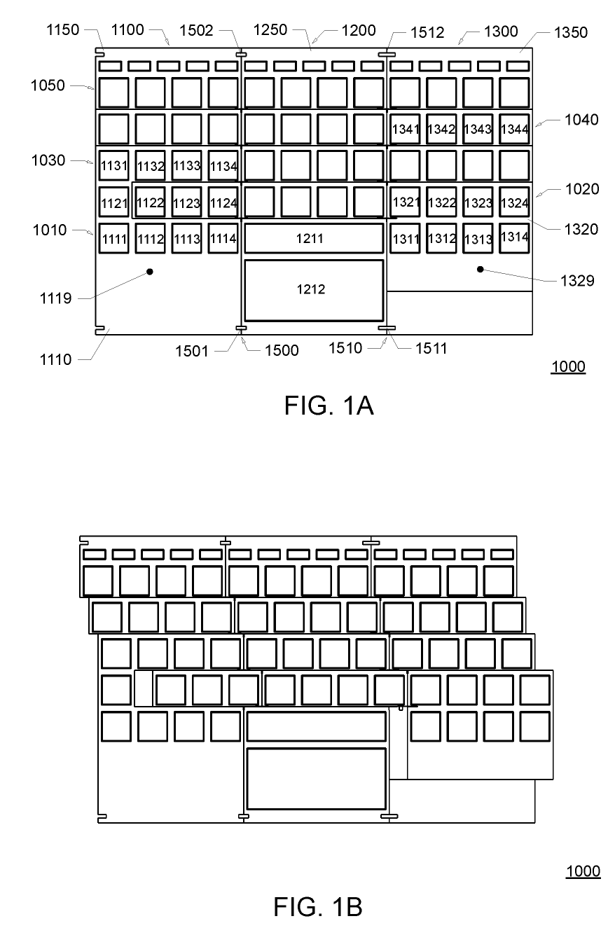

FIGS. 1-4 and the following description depict specific exemplary embodiments of the invention to teach those skilled in the art how to make and use the best mode of the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1A shows a top view of tri-folding computer keyboard 1000 where key rows are slid to align the keys vertically. The keys are arranged in key banks in five rows 1010, 1020, 1030, 1040, and 1050, and three columns 1100, 1200, and 1300. Key banks are number per their row and column where key bank 1150 is in column 1100 and row 1050, key bank 1320 is in column 1300 and row 1020, and so on. Most key banks have four keys numbered per their key bank. For example, key bank 1340 contains keys 1341, 1342, 1343, and 1344. The three key banks in row 1050, numbered 1150, 1250, and 1350, have 9 keys each consisting of a row of four standard keys and a row of 5 smaller function keys. Key bank 1110 also has 9 keys consisting of a row of four standard keys 1111 through 1114, a row with one standard key 1121, and a second row of four standard keys 1131 through 1134. Key bank 1110 also contains grip point 1119. Key bank 1120 only contains three keys 1122 through 1124. Key bank 1210 contains a single spacebar key 1211 and track pad 1212. Key bank 1310 does not have any keys. Key bank 1320 has 8 keys consisting of a row of four keys 1321 through 1324 and a second row of four keys 1311 through 1314. Key bank 1320 also has button 1329.

FIG. 1B shows a top view of keyboard 1000 where the key rows are slid into a standard QWERTY keyboard configuration for typing. The keyboard moves from the vertically aligned configuration of FIG. 1A to the staggered configuration of FIG. 1B by gripping the keyboard at points 1119 and 1329 and pulling outward one half of a key width. This directly causes key banks 1120, 1220, and 1320 to slide right relative to key banks 1110, 1210 and 1310. The unique shape of key bank 1110 forces the key banks in row 1030 to remain vertically aligned with the key banks in row 1010. Linkages internal to keyboard 1000 force the key banks in rows 1040 and 1050 to shift left one quarter of a key width each.

The keyboard moves back into the vertically aligned configuration in FIG. 1A by gripping keyboard 1000 at points 1119 and 1329 and pushing inwards. When the keys are vertically aligned, the breaks between key banks in the columns are also aligned, revealing fold axes 1500 and 1510. Hinge links 1501 and 1502 tie column 1100 to column 1200 across fold axis 1500. Hinge links 1511 and 1512 tie columns 1200 to column 1300 across fold axis 1510.

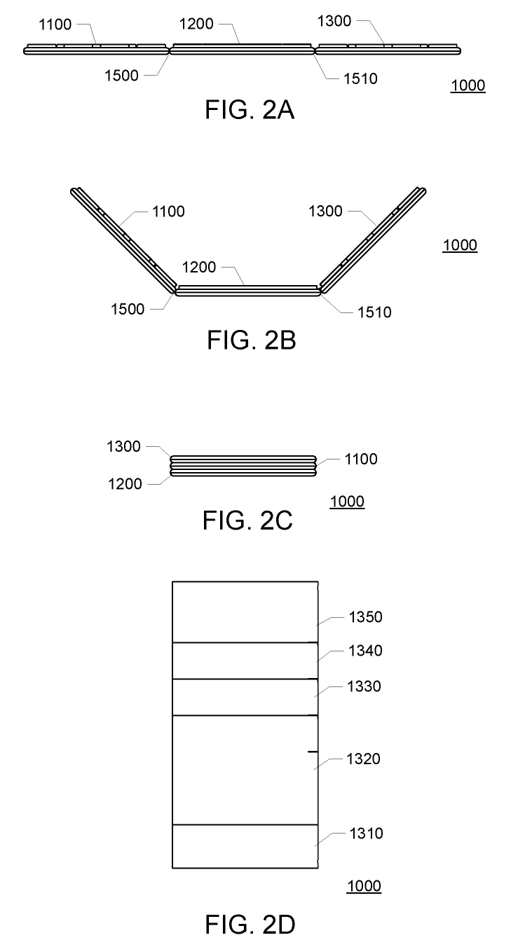

FIG. 2A shows and end view of keyboard 1000 in the vertically aligned configuration shown in FIG. 1A. Columns 1100, 1200, and 1300, and fold axes 1500 and 1510 are denoted. In FIG. 2B, columns 1100 and 1300 are beginning to fold up along axes 1500 and 1510 respectively. In FIG. 2C, columns 1100 and 1300 are rotated a full 180 degrees so all columns are stacked atop one another. Hinge links 1511 and 1512 are longer than hinge links 1501 and 1502 to allow column 1300 to stack above column 1100. FIG. 2D shows a top view of keyboard 1000 in its folded configuration where the back side of the key banks in column 1300 are visible.

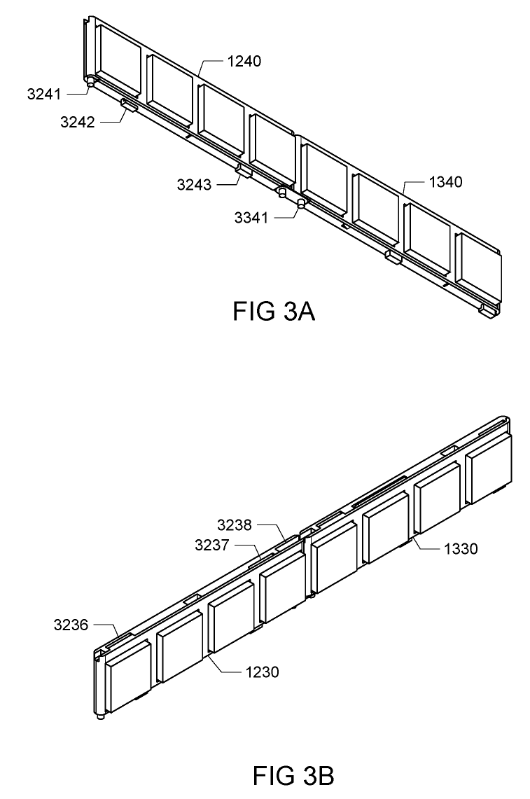

FIG. 3 shows isometric views of key banks 1240, 1340, 1230 and 1330 where they are separated to show how tabs 3242 and 3243 of key bank 1240 interlock with cavities 3236 and 3237 of key bank 1230 respectively. The tabs are not as wide as the cavities to allow the key banks to slide along one axis while remaining fixed along the other two axes.

When key bank 1240 and 1340 slide left relative to 1230 and 1330, peg 3341 slides into slot 3238. This will restrain the columns from folding when keyboard 1000 is in the staggered configuration in FIG. 1B.

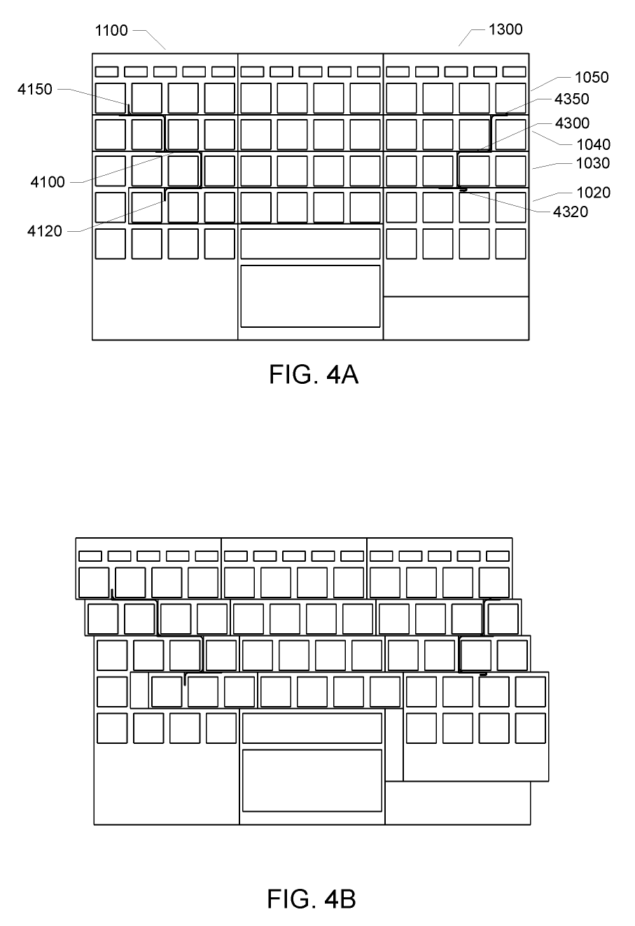

FIG. 4A and FIG. 4B is a cut-away view of the keyboard 1000 in the vertically aligned configuration of FIG. 1A and the staggered configuration of FIG. 1B respectively. The cut-away allows fixed length linkage straps 4100 in column 1100 and fixed length linkage strap 4300 in column 1300 to be visible. Strap 4100 is attached to key bank 1120 at endpoint 4120 and attached to key bank 1150 at endpoint 4150. Strap 4300 is attached to key bank 1320 at endpoint 4320 and attached to key bank 1350 at endpoint 4350. The fixed length straps cause row 1050 to move left relative to 1030 the same distance row 1020 moves right relative to row 1030. If the width of the tabs and cavities shown in FIG. 3 between rows 1050 and 1040 and between 1040 and 1030 only allow for one quarter of a key width slide, then row 1050 will slide one quarter key left of row 1040 and row 1040 will slide one quarter key left of 1030 when row 1020 is slid one half key width right of 1030.

Although specific embodiments were described herein, the scope of the invention is not limited to those specific embodiments. The scope of the invention is defined by the following claims and any equivalents therein.

I claim:

1. An apparatus with keys arranged in two or more horizontal rows where the key rows are fixed in a common plane and fixed vertically to one another but able to slide horizontally relative to one another.

2. The apparatus in claim 1 where the key rows can slide relative to one another such that the keys within the rows align vertically with the keys in the other rows.

3. The apparatus in claim 1 where the key rows can slide relative to one another such that the keys assume a staggered arrangement consistent with a standard QWERTY keyboard.

4. The apparatus in claim 2 where the apparatus is able fold along select axes between vertically aligned keys.

5. The apparatus in claim 4 where the apparatus folds along one axis.

6. The apparatus in claim 4 where the apparatus folds along two axes.

7. The apparatus in claim 4 where the apparatus folds along three axes.

8. The apparatus in claim 3 where overlapping protuberances between adjacent key rows restrict the apparatus from being able to fold.

9. The apparatus in claim 1 where mechanical linkages between rows restrict rows to only specific positions relative to one another.

10. The apparatus in claim 9 where the row of keys two rows up from the home row in a QWERTY keyboard slides left the same distance relative to the home row that the row immediately below the home row slides right relative to the home row.

11. The apparatus in claim 10 where the row of keys immediately above the home row slides in a position halfway between the home row and the row of keys two rows above the home row.

12. The apparatus in claim 9 where the row of keys two rows below the home row in a QWERTY keyboard stay in a fixed position relative to the home row.

13. The apparatus in claim 4 that is attached to a case for a smart-phone or tablet computer device

14. A method for sliding the rows of keys from the staggered arrangement of a QWERTY keyboard to an arrangement where the keys are aligned in vertical columns and where the keyboard is then folded along select vertical axes between columns of keys.

15. The method of claim 14 where the keyboard is folded along one vertical axis.

16. The method of claim 14 where the keyboard is folded along two vertical axes.

17. The method of claim 14 where the keyboard is folded along three vertical axis.

18. The method of claim 14 where sliding a first row to a fixed position relative to a second row causes other rows to assume fixed positions based on the relative positions of the first and second rows.
